(19) United States
(12) Patent Application Publication
(10) Pub. No.: US 2026/0303734 A1
(43) Pub. Date: Oct. 1, 2026

(54) ELECTRONIC DEVICE

(71) Applicant: SEIKO EPSON CORPORATION, TOKYO (JP)

(72) Inventor: Shoichi MURATA, YAMAGATA-MURA (JP)

(21) Appl. No.: 19/461,995

(22) Filed: Jan. 28, 2026

(30) Foreign Application Priority Data
Jan. 28, 2025 (JP) 2025-012009

(51) Int. Cl. H04N 1/00

(52) U.S. Cl. CPC H04N 1/00551; H04N 1/00557

(57) ABSTRACT

An electronic device includes the outer case includes a cover member configured to cover a communication interface and a cable connected to the communication interface and the cover member is mounted to the outer case from downward toward upward and is attachable to and detachable from the outer case.

The present application is based on, and claims priority from JP Application Serial Number 2025-012009, filed Jan. 28, 2025, the disclosure of which is hereby incorporated by reference herein in its entirety.

### BACKGROUND

### 1. Technical Field

The present disclosure relates to an electronic device.

### 2. Related Art

JP-A-2023-117589 discloses an electronic device in which an outer case includes a communication interface and a cover member that covers a cable connected to the communication interface.

The cover member of the electronic device is, for example, transported in the same package as the electronic device, and is unpacked and attached to the electronic device when the electronic device is installed. The cover member is attached to and detached from the electronic device by a snap fit structure without requiring a tool.

However, in the electronic device of related art, since the cover member is attached to the outer case from the rear, the fitting strength of the snap fit structure has to be increased in order to prevent the cover member from coming off rearward when the electronic device is used. When the hook shape is enlarged to increase this strength, there is a problem that the size of the cover member increases.

The present disclosure has an object to solve the problems of the techniques of related art described above and provide an electronic device including a cover member that can be easily attached to an outer case and is not easily detached rearward without increasing the size.

### SUMMARY

An electronic device according to present disclosure includes an outer case, wherein the outer case includes a cover member configured to cover a communication interface and a cable connected to the communication interface and the cover member is mounted to the outer case from downward toward upward and is attachable to and detachable from the outer case.

### BRIEF DESCRIPTION OF THE DRAWINGS

FIG. 1 is a perspective view of a check scanner.

FIG. 2 is a perspective view of the check scanner as viewed from the back.

FIG. 3 is a perspective view illustrating a state in which a cover member is removed.

FIG. 4 is a perspective view illustrating a state in which the cover member is attached.

FIG. 5 is a perspective view of the cover member.

FIG. 6 is a side view of the cover member.

FIG. 7 is a partially sectional perspective view illustrating an engaged state of the cover member.

### DESCRIPTION OF EMBODIMENTS

### First Embodiment

### Configuration

Hereinafter, a first embodiment of the present disclosure will be described with reference to the drawings.

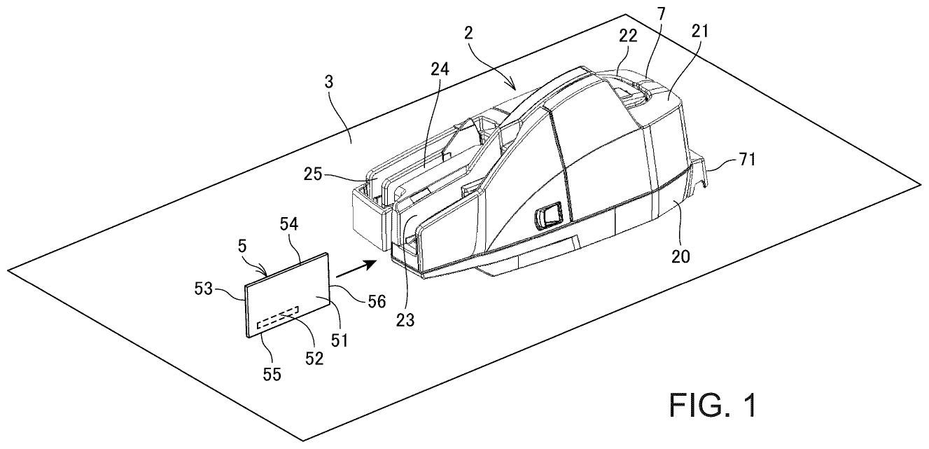

FIG. 1 is a perspective view of a check scanner 2. The check scanner 2 is an example of an electronic device. The present disclosure is not limited to the check scanner 2, and can be applied to various electronic devices such as a printer.

The check scanner 2 is a device that reads Magnetic Ink Character Recognition (MICR) characters recorded on a check 5, recognizes the MICR characters that were read, and reads both sides of the check 5.

The check scanner 2 includes an outer case 7, and the outer case 7 is disposed on a table 3. The outer case 7 includes a main body case 20 and a lid case 21 covering the upper side of the main body case 20, and various components are incorporated inside the main body case 20 and the lid case 21. A transport path 22 for the check 5, which is a U-shaped vertical groove, is formed in the lid case 21. One end of the transport path 22 is connected to a check supply section 23 formed of a vertical groove having a width larger than that of the transport path 22. The other end of the transport path 22 is connected to a first check discharge section 24 and a second check discharge section 25, which are formed of vertical grooves having a width larger than that of the transport path 22.

The amount, the drawer, the signature, and the like are written on a front surface 51 of the check 5 with a formed pattern as a background. A MICR character string 52 extending in an elongated side direction is recorded on a lower edge portion of the front surface 51 of the check 5. In the MICR character string 52, a plurality of MICR characters are arranged in the elongate direction. An endorsement field is formed on a back surface 53 of the check 5. In the endorsement field, a predetermined image or character related to endorsement is recorded.

The check 5 is inserted into the check supply section 23 in an upright orientation in which an upper edge 54 is positioned upward and a lower edge 55 is positioned below, and in an orientation in which the front and back are aligned so that the front surface 51 faces the outside of the U-shaped transport path 22. The check 5 inserted into the check supply section 23 is sent out and transported to the transport path 22 while maintaining the upright orientation with a trailing edge 56 as the front.

While the check 5 sent out from the check supply section 23 is transported along the transport path 22, the front surface 51 and back surface 53 are read and the MICR character string 52 recorded on the front surface 51 is magnetically read. If the MICR character string 52 reading and the image quality evaluation of the read image are successful, the check 5 is discharged to the first check discharge section 24 after a specific image and text related to endorsements are recorded.

On the other hand, if the MICR character string reading 52 and the image quality evaluation of the read image fail, the check 5 is discharged to the second check discharge section 25 without recording the specific endorsement image or characters. The check 5 discharged to the second check discharge section 25 is subjected to processes such as investigation of the cause of the reading failure and re-reading.

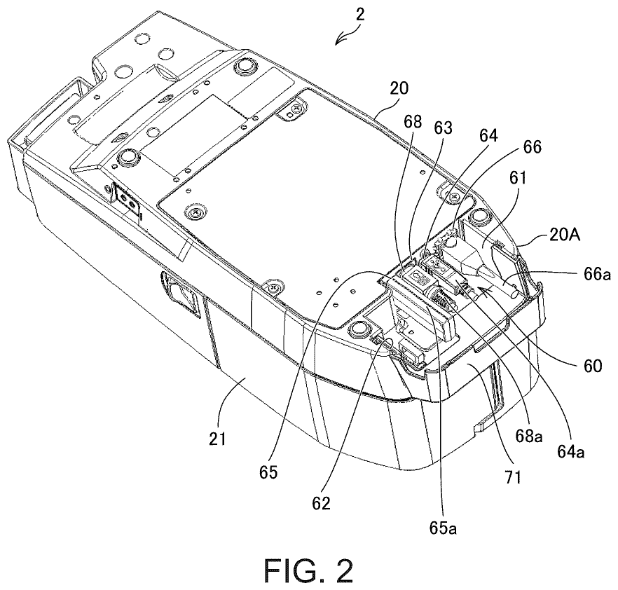

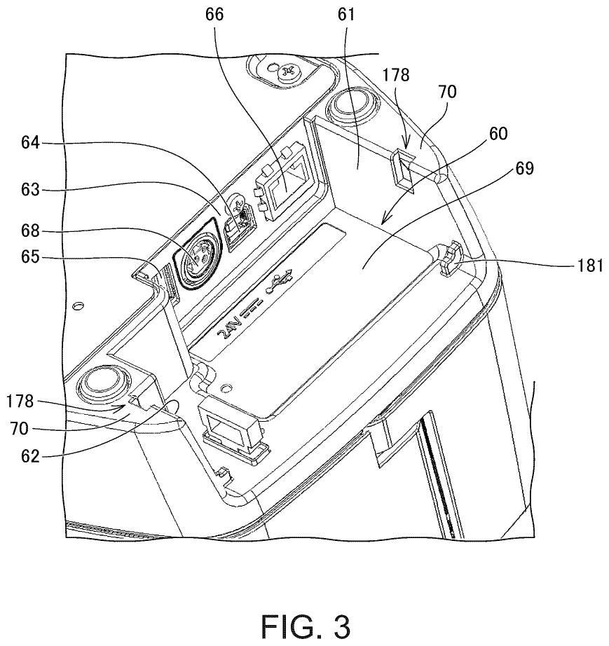

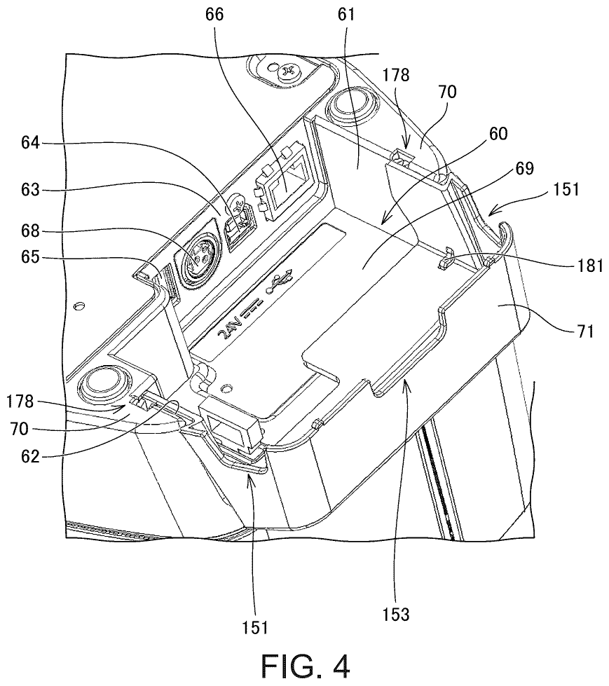

FIG. 2 is a perspective view of the check scanner 2 as viewed from the back. FIG. 3 and FIG. 4 are enlarged views of the same, FIG. 3 illustrates a state where a cover member 71 (to be described later) is removed, and FIG. 4 illustrates a state where the cover member 71 is attached.

The main body case 20 includes a step section 60 having a substantially rectangular shape in a plan view at a lower portion of a back surface 20A. The step section 60 is surrounded by a pair of first wall sections 61 and 62 and a second wall section 63.

A Universal Serial Bus (USB) I/F 64 is disposed on the second wall section 63. The I/F is an abbreviation for interface. The USB I/F 64 is connected to a PC (not illustrated) via a USB cable 64a.

An Ethernet I/F 66 is disposed on the second wall section 63. The Ethernet is a registered trademark. The Ethernet I/F 66 is connected to an image server (not illustrated) via an Ethernet cable 66a. The Ethernet I/F 66 may be a wired communication interface or a wireless communication interface. The Ethernet I/F is an example of a “communication interface”. The Ethernet cable 66a is an example of a “cable connected to a communication interface”.

A power source I/F 68 is disposed on the second wall section 63. The power source I/F 68 is connected to a power source via a power cable 68a.

A dongle I/F 65 is disposed on the second wall section 63. A dongle 65a equipped with a USB-A terminal is connected to the dongle I/F 65. The dongle 65a includes a communication function by a wireless LAN and is connected to an image server (not illustrated) for communication. Note that the connection between the dongle I/F 65 and the dongle 65a is not limited to the connection by USB-A, and may be a connection by USB-B or USB-C, or may be a connection method other than USB as long as it is electrically attachable and detachable.

The cover member 71 is attached to the step section 60 of the main body case 20 of the outer case 7. The cover member 71 is attached with respect to the step section 60 of the outer case 7 from downward toward upward, and is attachable to and detachable from the main body case 20.

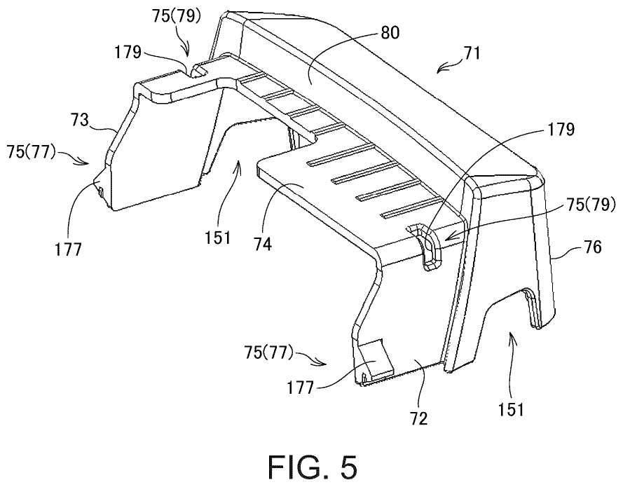

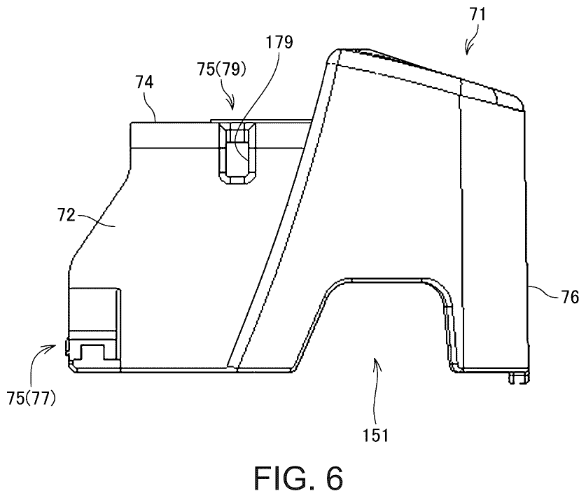

FIG. 5 is a perspective view of the cover member 71, and FIG. 6 is a side view of the cover member 71.

The cover member 71 covers a part of the USB cable 64a, the Ethernet cable 66a, and the power cable 68a, and includes a pair of side surface plates 72 and 73, an upper surface plate 74, and a back surface plate 76. The lower edges of the pair of side surface plates 72 and 73 and the back surface plate 76 of the cover member 71 are flush with the lower end of the main body case 20 when the cover member 71 is attached on the step section 60. The upper surface plate 74 of the cover member 71 is bent at an intermediate portion thereof, and a step surface 80 is formed so that the rear side of the upper surface plate 74 is higher. As shown in FIG. 4, the upper surface plate 74 of the cover member 71 contacts against an upper wall section 69 of the step section 60 on the front side of the step surface 80.

An engagement section 75 is provided between the step section 60 of the outer case 7 and the cover member 71. The engagement sections 75 are disposed on both sides of the cover member 71 in a bilaterally symmetrical manner.

The engagement section 75 includes a first engagement section 77 and a second engagement section 79.

The first engagement section 77 includes a claw member 177, and the claw member 177 is disposed in a lower portion of each of the side surface plates 72 and 73 of the cover member 71.

The pair of side surface plates 72 and 73 of the cover member 71 include side surface openings 151 through which the USB cable 64a, the Ethernet cable 66a, and the power cable 68a pass. As shown in FIG. 4, the back surface plate 76 of the cover member 71 includes a back surface opening 153 through which the USB cable 64a, the Ethernet cable 66a, and the power cable 68a pass.

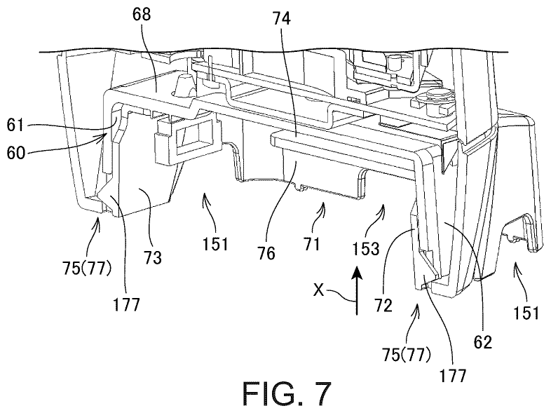

FIG. 7 is a partially sectional perspective view illustrating an engaged state of the cover member 71.

The cover member 71 is attached with respect to the step section 60 of the outer case 7 from downward toward upward as indicated by an arrow X in FIG. 7.

When the cover member 71 is attached to the outer case 7, the claw member 177 of the first engagement section 77 is fitted into a groove section 178 of the step section 60, and the outer case 7 and the cover member 71 are engaged with each other. That is, when the cover member 71 is attached in the direction of the arrow X, the claw member 177 comes into contact with a lower section wall 70 of the outer case 7, is once bent inward integrally with the side surface plates 72 and 73, and when it reaches the position of the groove section 178, it is elastically fitted into the groove section 178. The side surface plates 72 and 73 of the cover member 71 are flexible in the inward and outward directions.

As illustrated in FIG. 5, the second engagement section 79 includes a notch groove 179 disposed at a corner portion of the cover member 71. Here, the corner portions of the cover member 71 are the corner portions that connect the side surface plates 72 and 73 and the upper surface plate 74 of the cover member 71. When the cover member 71 is attached to the step section 60 of the outer case 7 in the direction of the arrow X, as shown in FIG. 4, the protrusion section 181 is fitted into the notch groove 179 of the second engagement section 79. As illustrated in FIG. 3, a protrusion section 181 is formed on the step section 60, and is formed at the corner portion between the pair of first wall sections 61 and 62 and the upper wall section 69.

When the cover member 71 is removed from the outer case 7, the cover member 71 may be pulled out from top to bottom and removed in a state where the side surface plates 72 and 73 of the cover member 71 are bent inward and the claw member 177 is separated from the groove section 178.

### Operation and Effect

According to the first embodiment, the cover member 71 is attached with respect to the step section 60 of the outer case 7 from downward toward upward, and is attachable to and detachable from the outer case 7. Therefore, when the check scanner 2 is used, the cover member 71 is not easily detached in the rearward direction perpendicular to the attaching direction of the cover member 71, and it is not necessary to increase the fitting strength of the snap fit structure as in the related art. Therefore, it is not necessary to increase the size of the hook shape, and the size of the cover member 71 can be reduced.

According to the first embodiment, the outer case 7 is installed on the table 3. According to this, since the cover member 71 is attached with respect to the step section 60 of the outer case 7 from downward toward upward, even if the cover member 71 falls off from the step section 60, the cover member 71 is supported by the table 3 and does not fall off to the floor.

According to the first embodiment, when the cover member 71 is attached on the step section 60, the lower edges of the pair of side surface plates 72 and 73 and the back surface plate 76 of the cover member 71 are flush with the lower end of the main body case 20. Note that the term “flush” in the present application includes “approximately flush”. Therefore, when the check scanner 2 is installed on the table 3, the cover member 71 does not fall off in the attaching direction of the cover member 71, that is, downward.

According to the first embodiment, the upper surface plate 74 of the cover member 71 contacts against the upper wall section 69 of the step section 60, and thus, the upper surface plate 74 and the step surface 80 can make it difficult for the cover member 71 after attachment to rotate with respect to the outer case 7.

According to the first embodiment, since the first engagement section 77 is provided between the step section 60 of the outer case 7 and the cover member 71, the outer case 7 has a structure that is not easily detached rearward. The first engagement section 77 engages the outer case 7 and the cover member 71 by the snap fit structure, but it is not necessary to increase the fitting strength, and it is not necessary to increase the size of the hook shape, and the size of the cover member 71 can be reduced.

According to the first embodiment, since the second engagement section 79 is provided between the step section 60 of the outer case 7 and the cover member 71, the structure has a structure that is more difficult to be detached rearward. The second engagement section 79 has a structure in which the protrusion section 181 is simply fitted with respect to the notch groove 179, and this fitting is achieved by simply attaching the cover member 71 with respect to the step section 60 of the outer case 7 from downward toward upward, and thus the workability of fitting is improved.

According to the first embodiment, the engagement section 75 includes the first engagement section 77 and the second engagement section 79, but the present disclosure is not limited to this. The second engagement section 79 may be omitted.

According to the first embodiment, the first engagement section 77 and the second engagement section 79 are provided on both sides of the cover member 71. That is, the cover member 71 includes the pair of side surface plates 72 and 73, the upper surface plate 74, and the back surface plate 76, and the first engagement section 77 and the second engagement section 79 are provided on each of the pair of side surface plates 72 and 73. According to this configuration, the cover member 71 is further less likely to be detached rearward.

According to the first embodiment, the pair of side surface plates 72 and 73 of the cover member 71 include the side surface openings 151 through which the USB cable 64a, the Ethernet cable 66a, and the power cable 68a pass. The back surface plate 76 of the cover member 71 includes the back surface opening 153 through which the USB cable 64a, the Ethernet cable 66a, and the power cable 68a pass. This facilitates the handling of the cable.

### Other Embodiments

For example, the above described embodiment merely illustrates one aspect of the present disclosure, and can be arbitrarily modified and applied without departing from the gist of the present disclosure.

In the first embodiment, the second engagement section 79 is described as an example in which the protrusion section 181 formed on the step section 60 is fitted into the notch groove 179 disposed at the corner portion of the cover member 71. However, a configuration may be adopted in which a protrusion section is formed at a corner portion of the cover member and a notch groove is provided in the step section, so that the protrusion of the cover member is fitted into the notch groove of the step section.

What is claimed is:

1. An electronic device comprising:
an outer case, wherein
the outer case includes a cover member configured to cover a communication interface and a cable connected to the communication interface and
the cover member is mounted to the outer case from downward toward upward and is attachable to and detachable from the outer case.

2. The electronic device according to claim 1, wherein the outer case is installed on a table.

3. The electronic device according to claim 1, wherein
the outer case includes a step section in a lower portion of a back surface,
the step section includes the communication interface, and
the cover member is attached with respect to the step section of the outer case from downward toward upward and is attachable to and detachable from the outer case.

4. The electronic device according to claim 3, wherein
the cover member includes an engagement section configured to engage with the outer case.

5. The electronic device according to claim 4, wherein
the engagement section is provided on both sides of the cover member.

6. The electronic device according to claim 4, wherein
the engagement section includes a first engagement section,
the first engagement section includes a claw member disposed on a side surface of the cover member, and
a groove section with which the claw member engages is disposed in the outer case.

7. The electronic device according to claim 4, wherein
the engagement section includes a second engagement section,
the second engagement section includes a notch groove disposed at a corner portion of the cover member, and
a protrusion section configured to engage with the notch groove is disposed on the outer case.

8. The electronic device according to claim 4, wherein
the engagement section includes a first engagement section and a second engagement section,
the first engagement section includes a claw member disposed on a side surface of the cover member,
a groove section with which the claw member engages is disposed in the outer case,
the second engagement section includes a notch groove disposed at a corner portion of the cover member, and
a protrusion section configured to engage with the notch groove is disposed on the outer case.

9. The electronic device according to claim 4, wherein
the cover member includes a pair of side surface plates, an upper surface plate, and a back surface plate, and the engagement section is provided on each of the pair of side surface plates.

10. The electronic device according to claim 9, wherein
when the cover member is attached to the outer case, the upper surface plate contacts against a surface of the step section of the outer case.

11. The electronic device according to claim 9, wherein
the side surface plate includes a side surface opening section configured to pass the cable.

12. The electronic device according to claim 9, wherein
the back surface plate includes a back surface opening section configured to pass the cable.
